(19) United States
(12) Patent Application Publication
(10) Pub. No.: US 2007/0188034 A1
(43) Pub. Date: Aug. 16, 2007

(54) Electric motor and fan unit employing the same

(75) Inventor: Yusuke Yoshida, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/706,285

(22) Filed: Feb. 15, 2007

(30) Foreign Application Priority Data
Feb. 16, 2006 (JP) 2006-039869

(51) Int. Cl. H02K 7/00; H02K 5/16; H02K 1/22; F04B 17/00; H02K 11/00

(52) U.S. Cl. 310/90; 310/67 R; 310/261; 417/354; 417/423.12

(57) ABSTRACT

A ring-shaped member is secured to a shaft of a motor between a portion of the shaft connected to a rotor and a sleeve accommodating the shaft and impregnated with lubricating oil. The ring-shaped member is coated with a repellent agent repelling the lubricating oil. An outer diameter of the ring-shaped member at its sleeve side, i.e., a first outer diameter is larger than that at the opposite side, i.e., a second outer diameter. A shaft-retaining portion is provided between the connected portion of the shaft and the ring-shaped member. A diameter of the hole is larger than the first outer diameter and smaller than the second outer diameter. At least one of the ring-shaped member and the shaft-retaining portion is elastically deformable.

### BACKGROUND OF THE INVENTION

1. Field of the Invention

The present invention relates to an electric motor and a fan unit using the same. More particularly, the present invention relates to an electric motor including a shaft, a sleeve impregnated with lubricating oil and supporting the shaft in a rotatable manner, and a housing having a cylindrical portion accommodating the sleeve, and a fan unit using the motor.

2. Description of the Related Art

There are various known electric motors for rotating an impeller of an electric fan or a disk. Some electric motors use a sliding bearing in which a shaft is supported in a rotatable manner around a rotation axis by a sleeve formed of sintered material impregnated with lubricating oil. In those electric motors, it is necessary to prevent oil leak to the outside of a portion accommodating the sleeve. Japanese Unexamined Patent Publication No. 2001-25200 discloses that an oil-returning portion in the form of a washer is provided around the shaft. A face of the oil-returning portion facing the sleeve is curved and concave away from the sleeve. Lubricating oil leaking from the sleeve in an axial direction parallel to the rotation axis reaches the oil-returning portion and is then returned to the sleeve.

For electric motors, there are proposed various arrangements for preventing the shaft connected to a rotor from escaping from the sliding bearing in the axial direction. Japanese Patent No. 3003763 and Japanese Unexamined Patent Publication No. 2000-102210 disclose the use of a shaft-retaining ring, for example. The shaft-retaining ring is provided on a part of a housing of the motor, and loosely fits into an annular groove formed on a circumferential surface of the shaft near an end of the shaft over an entire circumferential length of the shaft.

In this arrangement, however, it is difficult to obtain a satisfactory level of a shaft-retaining force in some cases, especially in a case where the diameter of the shaft is small. This is because the shaft-retaining ring engages with the annular groove formed over the entire circumferential length of the shaft. Moreover, the shaft has to be made longer to ensure a region in which the annular groove is formed near the shaft's end, as compared with a shaft with no annular groove. This increase in length of the shaft increases the axial dimension of the motor. In addition, it is necessary to set both dimensional accuracy and assembly accuracy of various parts of the motor to be high in order to prevent constant contact of the shaft-retaining ring with the annular groove formed around the shaft. Thus, parts cost and assembly cost increase.

Furthermore, the shaft-retaining ring of Japanese Unexamined Patent Publication No. 2000-102210, which is formed by a spring, has a function of preventing leak of lubricating oil. However, this function is not provided on a side of the shaft where the rotor is connected to the shaft, but on the other side of the shaft located deep in the cylindrical portion. A rotor side end of the cylindrical portion is usually open, whereas the other end is usually closed with a bottom extending from a circumferential wall of the cylindrical portion or a cap fitted into an opening of the cylindrical portion. Therefore, lubricating oil axially leaking from the sleeve hardly leaks to the outside of the cylindrical portion from the closed end of the cylindrical portion. Instead, it is necessary to effectively prevent lubricating oil leak from the open end of the cylindrical portion.

### SUMMARY OF THE INVENTION

According to preferred embodiments of the present invention, a motor includes: a shaft rotatable around a rotation axis and connected in its connection part to a rotor; a sleeve impregnated with lubricating oil, surrounding the shaft except for the connection part of the shaft, and supporting the shaft in a rotatable manner; a hollow cylindrical portion having an open end and accommodating the sleeve; a ring-shaped member secured around the shaft between the connection part of the shaft and the sleeve and coated with a repellent agent repelling the lubricating oil, an outer peripheral surface of the ring-shaped member facing the hollow cylindrical portion, the ring-shaped member having a first outer diameter at its sleeve side and a second outer diameter at its connection-part side larger than the first outer diameter; and a shaft-retaining portion defining a hole therein and provided on the hollow cylindrical portion to be located between the connection part of the shaft and the ring-shaped member, a diameter of the hole being larger than the first outer diameter and smaller than the second outer diameter of the ring-shaped member. In the motor, at least one of the ring-shaped member and the shaft-retaining portion is elastically deformable.

The ring-shaped member may be tapered toward the sleeve in such a manner that the first outer diameter is smaller than the second outer diameter. Moreover, the outer peripheral surface of the ring-shaped member may be stepped.

The motor may further include a stator including a core, a coil wound around the core, and an insulator insulating the core from the coil, the stator being secured to an outer peripheral surface of the hollow cylindrical portion. The shaft-retaining portion is formed by a part of the insulator.

The ring-shaped member may be a pressed metal member.

It is preferable that a layer of the repellent agent repelling the lubricating oil be formed on a surface of the ring-shaped member by immersing the ring-shaped member in the repellent agent.

A sleeve side face of the ring-shaped member may be concave in such a manner that the sleeve side face gets close to the sleeve radially outward.

According to preferred embodiments of the present invention, a fan unit is provided. The fan unit includes the aforementioned motor and an impeller generating an air flow by its rotation. The impeller is connected to the shaft of the motor directly or via a rotor hub.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is an exploded perspective view of a fan unit using an electric motor according to a preferred embodiment of the present invention.

FIG. 2 is a cross-sectional view of the fan unit of FIG. 1.

FIG. 3 is a perspective view of a housing of the fan unit of FIG. 1, with a circuit board and a stator attached thereto.

FIG. 4 is a cross-sectional view of the fan unit of FIG. 1, while a rotating part and a stationary part are separated from each other.

FIG. 5 shows the stator of the fan unit of FIG. 1, when seen from above.

FIG. 6 is a partial, enlarged cross-sectional view of a ring-shaped member, a shaft-retaining portion and components around them in the fan unit of FIG. 1.

FIGS. 7A to 7F are cross-sectional views showing modified examples of the ring-shaped member in the fan unit of FIG. 1.

### DETAILED DESCRIPTION OF PREFERRED EMBODIMENTS

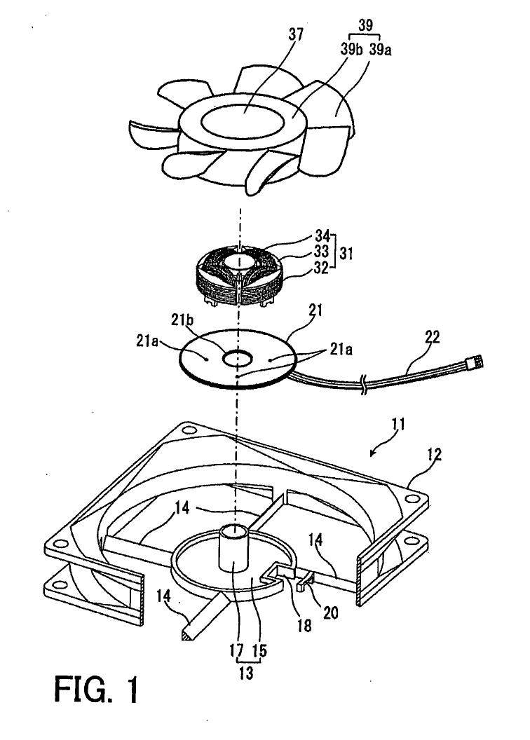

Referring to FIGS. 1 through 7F, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

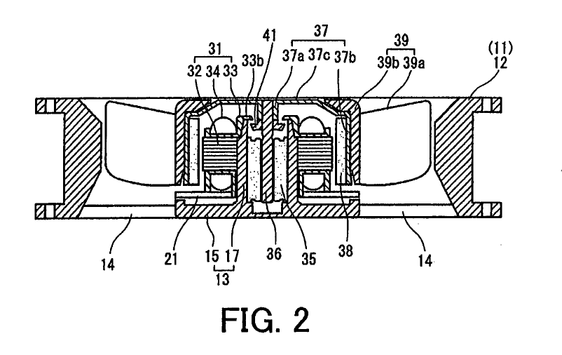

FIG. 1 is an exploded perspective view of a fan unit using a motor according to a preferred embodiment of the present invention. FIG. 2 is a cross-sectional view of the fan unit of FIG. 1. This fan unit includes a housing 11 formed of resin, having an approximately rectangular outer shape when seen in an axial direction, a circuit board 21 secured to a center of the housing 11, a stator (armature) 31 forming a part of a motor, a rotor hub 37 connected to a shaft 36 rotatable around a rotation axis, and an impeller 39 secured on an outer peripheral surface of the rotor hub 37. The rotor hub 37 and the impeller 39 are also referred to collectively as a rotor.

Referring to FIG. 1, the housing 11 includes an outer frame 12. In FIG. 1, the outer frame 12 of the housing 11 is partially omitted for improving visualization. An outer periphery and an inner periphery of the outer frame 12 are approximately rectangular and approximately circular, respectively, when seen in the axial direction. In the housing 11, a motor supporting portion 13 is located at a center of the outer frame 12 and has an approximately circular shape when seen in the axial direction. The motor supporting portion 13 is connected to the outer frame 12 with four ribs 14. The number of the ribs 14 is not limited to four. Less than four or more than four ribs may be provided.

A space between an inner peripheral surface of the outer frame 12 and an outer peripheral surface of the motor supporting portion 13 forms a passage for an air flow generated by rotation of the impeller 39. A plurality of blades 39a of the impeller 39 are arranged in the air-flow passage.

Referring to FIG. 1, the motor supporting portion 13 includes a plate-like portion 15 in the form of an approximately circular plate and a cylindrical portion 17 standing substantially at a center of the plate-like portion 15. The cylindrical portion 17 defines a space therein and accommodates in the space a sleeve 35 forming a bearing for the shaft 36. The cylindrical portion 17 also retains the stator 31. The stator 31 is attached to an outer peripheral surface of the cylindrical portion 17, as shown in FIG. 2.

The sleeve 35 accommodated in the cylindrical portion 17 is secured to an inner circumferential surface of the cylindrical portion 17. The sleeve 35 is formed of sintered alloy impregnated with lubricating oil, and forms a sliding bearing for supporting the shaft 36 in a rotatable manner while surrounding the shaft 36 except for at least an upper part of the shaft 36. The upper part of the shaft 36 is connected to the rotor hub 37. More specifically, a central cylindrical portion 37a of the rotor hub 37, which is hollow, open downward, and made of metal, is fitted and secured to an outer peripheral surface of the upper part of the shaft 36, as shown in FIG. 2. Hereinafter, the upper part of the shaft 36 is referred to as a connection part.

The rotor hub 37 includes the central cylindrical portion 37a connected to the shaft 36, an intermediate portion 37c extending from an upper end of the central cylindrical portion 37a outward in a radial direction perpendicular to the axial direction, and an outer peripheral wall 37b extending downward from an outer peripheral edge of the intermediate portion 37c. The outer peripheral wall 37b is arranged to encircle the shaft 36, the sleeve 35, and the cylindrical portion 17. A hollow cylindrical rotor magnet 38 forming a part of the motor is hollow and is fitted and fixed to an inner surface of the outer peripheral wall 37b in such a manner that an inner peripheral surface of the rotor magnet 38 faces an outer peripheral face of a core 32 (described later) of the stator 31 with a gap interposed therebetween. To an outer surface of the outer peripheral wall 37 is attached the impeller 39 formed of resin. More specifically, a cylindrical portion 39b of the impeller 39, on which a plurality of blades 39 are provided, is fitted and fixed to the outer surface of the outer peripheral wall 37b.

Referring to FIG. 2, a ring-shaped member 41 is provided around the shaft 36. The ring-shaped member 41 is fitted and fixed to the outer peripheral surface of the shaft 36 immediately below the connection part of the shaft 36 connected to the central cylindrical portion 37a of the rotor hub 37. The ring-shaped member 41 is formed of metal by pressing and is coated with a repellant agent that repels lubricating oil. In this preferred embodiment, the ring-shaped member 41 is immersed in the repellant agent before assembled, thereby being coated with a layer of the repellant agent. Thus, the ring-shaped member 41 has a function of returning lubricating oil leaking upward from the sleeve 35 toward the sleeve 35 so as to prevent lubricating oil leak to the outside of the cylindrical portion 17.

The repellant agent can be applied onto the ring-shaped member 41 with brush or the like. However, immersion in the repellant agent is preferable as compared with application by brush. This is because the immersion in the repellent agent can surely coat the entire surface of the ring-shaped member with the repellent agent. Moreover, the immersion in the repellent agent is also preferable as compared with application using a dispenser. This is because the immersion in the repellent agent can apply the repellent agent in a larger area than the dispenser at one time. That is, the immersion in the repellent agent can form the coating of the repellent agent efficiently, irrespective of the size of the ring-shaped member 41. Furthermore, the immersion in the repellent agent can shorten a time required for forming the layer of the repellent agent on the ring-shaped member 41.

In addition, the ring-shaped member 41 has a function of preventing a rotating part including the shaft 36 from separating from a stationary part including the sleeve 35. Those functions of the ring-shaped member 41 will be described in detail later.

The stator 31 includes a core 32 having four-pole teeth. Both sides of the core 32 in the axial direction are covered with an insulator 33 formed of resin. A coil 34 is wound around each tooth. The insulator 33 insulates the core 32 and the coil 34 from each other. Start and end of the coil 34 are connected to terminal pins projecting downward from the insulator 33, respectively. The terminal pins are inserted through holes 21a provided in a circuit board 21 (see FIG. 1). The terminal pins are electrically connected and fixed to a land in a copper-foil pattern on a lower face of the circuit board 21, i.e., on a face opposite to a face facing the stator 31, by soldering. In this manner, the stator 31 forming a part of the motor is directly connected and fixed to the circuit board 21.

The circuit board 21 is formed by single-sided paper phenolic resin copper-clad laminate. The lower face of the circuit board 21 has copper foil formed thereon. The lower face can be called as a pattern face. Surface mount electronic parts forming a driving circuit of the motor (stator 31), such as an integrated circuit (chip IC), a chip resistor, and a chip capacitor are mounted on the lower face (pattern face) of the circuit board 21. Those electronic parts are electrically connected to each other via a conductive pattern formed on the circuit board 21.

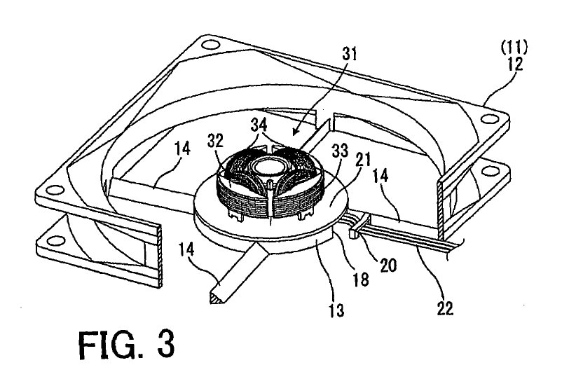

A through hole 21b is formed at a center of the circuit board 21, as shown in FIG. 1. The circuit board 21 is attached to the motor supporting portion 13 with the cylindrical portion 17 of the housing 11 inserted through the hole 21b. Since the stator 31 is attached and fixed directly to the circuit board 21, as described above, the circuit board 21 is fixed to the housing 11 via the stator 31 when the stator 31 is fixed to the outer circumferential surface of the cylindrical portion 17 of the housing 11. FIG. 3 is a perspective view showing the housing 11 of the fan unit of this preferred embodiment with the circuit board 21 and the stator 31 attached thereto.

A wire harness (lead wires with a connector) 22 for electric connection to an external power supply or the like is connected to the circuit board 21 by soldering. Alternatively, lead wires with no connector may be connected to the circuit board 21. In order to ensure a space for the wire harness 22 or allow easy soldering of the wire harness 22 onto the circuit board 21, a cutout portion 18 is formed on a periphery of the plate-like portion 15 of the motor supporting portion 13.

FIG. 1 shows a manner of attaching the circuit board 21 with the wire harness 22 connected thereto to the motor supporting portion 13 of the housing 11. In the example of FIG. 1, the cutout portion 18 is provided to prevent the motor supporting portion 13 from interfering with the wire harness 22 (and a soldered portion of the wire harness 22 on the circuit board 21), i.e., to provide a clearance for the wire harness 22 and the solder portion. In an alternative assembling method, the circuit board 21 with no wire harness 22 connected thereto is first attached to the motor supporting portion 13, and thereafter the wire harness 22 is soldered to a land for connection on the circuit board 21. In the latter method, the cutout portion 18 is used for enabling connection of the wire harness 22 to the circuit board 21 by soldering. Please note that one of the supporting ribs 14 near the cutout portion 18 includes a lead-wire retaining portion 20 that projects from that supporting rib 14 and retains the lead wires of the wire harness 22.

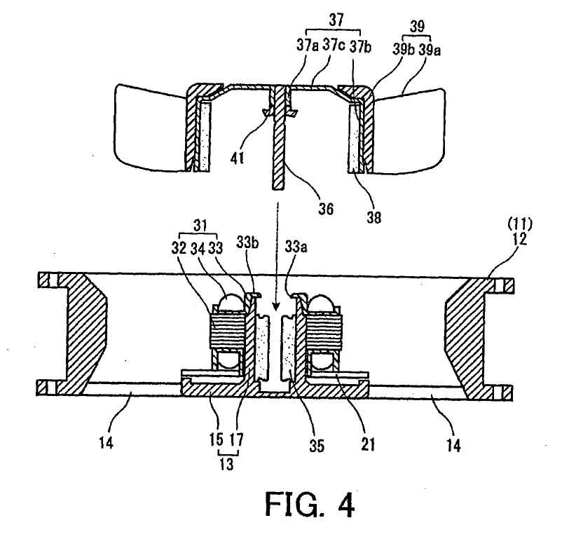

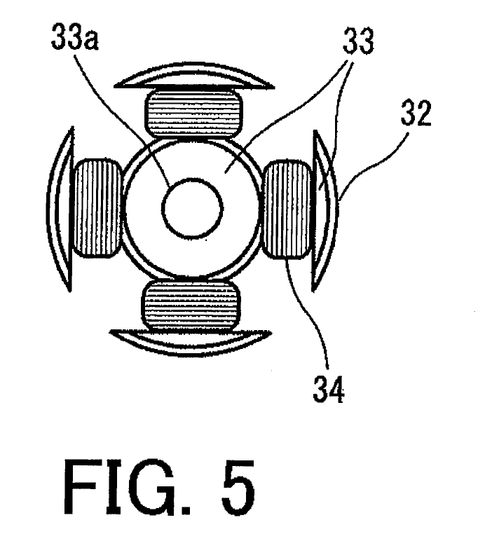

FIG. 4 is a cross-sectional view of the fan unit of this preferred embodiment, in which a rotating part and a stationary part are separated from each other. FIG. 5 illustrates the stator 31 when seen from above. An assembling method of the fan unit of this preferred embodiment is now described referring to FIGS. 4 and 5.

The stationary part of the motor is shown in a lower part of FIG. 4. In the stationary part, the stator 31 mounted on the circuit board 21 as described above is secured to the outer circumferential surface of the cylindrical portion 17 of the housing 11. The sleeve 35 formed of sintered alloy impregnated with lubricating oil, which forms a sliding bearing, is secured inside the cylindrical portion 17. The resin insulator 33 insulating the core 32 from the coil 34 has an upper end portion (shaft-retaining portion) 33b which is bent and extends toward the rotation axis to cover an upper end face of the cylindrical portion 17. The shaft-retaining portion 33b defines a hole 33a at its center. The hole 33a has a diameter smaller than an inner diameter of the cylindrical portion 17 of the housing 11. The shaft-retaining portion 33b may be formed as a separate part from stator 31. However, it is preferable that the shaft-retaining portion 33b be formed as a part of the stator 31 because the number of parts and the cost can be reduced.

The rotating part is shown in an upper part of FIG. 4. In the rotating part, the ring-shaped member 41 and the rotor hub 37 are attached to the shaft 36 near the upper end of the shaft 36. The rotor magnet 38 is secured to the inner surface of the outer peripheral wall 37b of the rotor hub 37. The impeller 39 is secured to the outer surface of the outer peripheral wall 37b. The ring-shaped member 41 is located between the connection part of the shaft 36 connected to the rotor hub 37 and a connection-part side end face, i.e., an upper end face of the sleeve 35 when the fan unit is assembled, as shown in FIG. 2.

An outer diameter (largest diameter) of the ring-shaped member 41 is larger than the diameter of the hole 33a formed by the shaft-retaining portion 33b of the insulator 33 of the stator 31. As shown with broken arrow in FIG. 4, the shaft 36 of the rotating part is inserted into the sleeve 35 of the stationary part through the hole 33a. When reaching the hole 33a, the ring-shaped member 41 causes elastic deformation of the shaft-retaining portion 33b to broaden the hole 33a and passes through the hole 33a. Then, the ring-shaped member 41 is placed in the state shown in FIG. 2. Therefore, at least the shaft-retaining portion 33b of the insulator 33 is arranged to be elastically deformable.

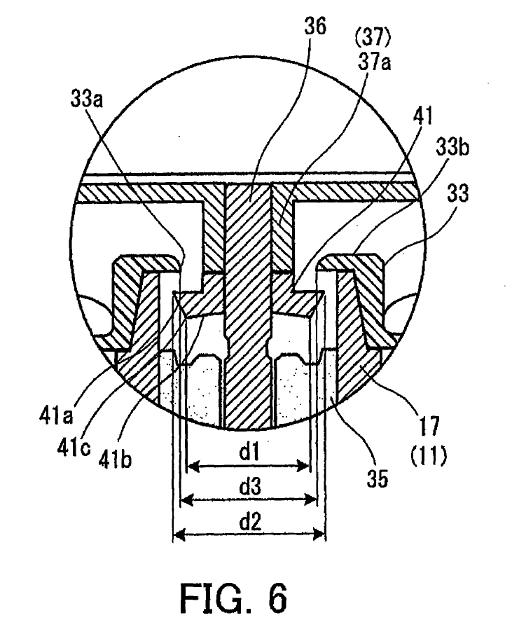

Next, the shape of the ring-shaped member 41 is described. FIG. 6 is a partial, enlarged cross-sectional view of the ring-shaped member 41, the shaft-retaining portion 33b, and components around them. As is apparent from FIG. 6, the ring-shaped member 41 is tapered toward the sleeve 35. That is, an outer peripheral surface 41a of the ring-shaped member 41, which faces the cylindrical portion 17 of the housing 11, is inclined with respect to the axial direction in such a manner that an outer diameter of the ring-shaped member 41 on the sleeve 35 side (that is referred to the first outer diameter d1) is smaller than that on the other side, i.e., the connection-part side (that is referred to the second outer diameter d2). Moreover, the diameter d3 of the hole 33a formed by the shaft-retaining portion 33b of the insulator 33 is larger than the first outer diameter d1 but is smaller than the second outer diameter d2, as shown in FIG. 6. That is, the dimensional relationship of d1<d3<d2 is satisfied.

Due to that dimensional relationship, the ring-shaped member 41 can easily pass through the hole 33a of the insulator 33 of the stationary part when the shaft 36 of the rotating part is inserted into the sleeve 35 through the hole 33. While passing through the hole 33a, the ring-shaped member 41 comes into contact with a region of the shaft-retaining portion 33b surrounding the hole 33a and broadens the hole 33a (i.e., causes elastic deformation of the shaft-retaining portion 33b). Thus, the layer of repellant agent formed on the outer peripheral surface 41a of the ring-shaped member 41 may be partially removed by the contact with the shaft-retaining portion 33b.

However, the layer of repellant agent is not removed at least in a lower part of the outer peripheral surface 41a because the first outer diameter d1, that is, the outer diameter d1 of the ring-shaped member 41 on the sleeve side is smaller than the diameter d3 of the hole 33a. In addition, the layer of repellant agent cannot be removed on a lower face 41b of the ring-shaped member 41 that faces the sleeve 35. Therefore, it is possible to effectively repel back lubricating oil leaking from the sleeve 35 axially upward toward the sleeve 35 by an action of the layer of repellant agent, thus preventing leak of lubricating oil to the outside of the cylindrical portion 17.

As shown in FIG. 6, the sleeve-side face (lower face) 41b of the ring-shaped member 41 is concave in such a manner that the face 41b gets closer to an upper end face of the sleeve 35 radially outward. With this arrangement, even if lubricating oil leaking upward from the sleeve 35 adheres to the sleeve-side surface 41b of the ring-shaped member 41, the adhering lubricating oil moves radially outward on the sleeve-side face 41b by a centrifugal force as the shaft 36 (and the ring-shaped member 41) rotates. After leaving a radially outer edge 41c of the sleeve-side face 41b of the ring-shaped member 41, the lubricating oil goes back to the sleeve 35. In this manner, the lubricating oil is effectively collected into the sleeve 35 and therefore does not leak to the outside of the cylindrical portion 17. The radially outer edge 41c formed by the outer peripheral surface 41a and the sleeve-side face (lower face) 41b also contributes to an effect of repelling the lubricating oil.

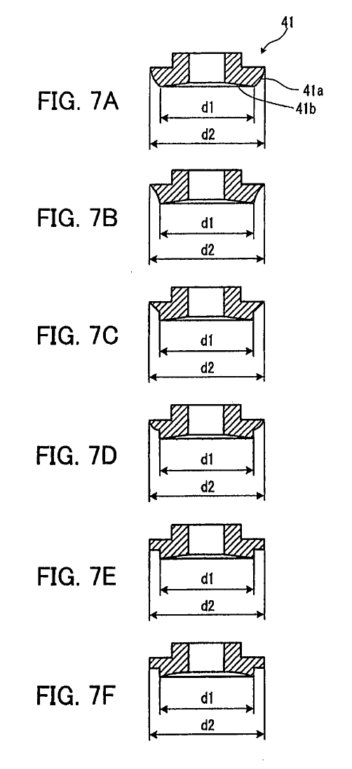

FIGS. 7A to 7F are cross-sectional views of exemplary modified ring-shaped members that can be used in the fan unit of the present preferred embodiment. Although the outer peripheral surface 41a in the example of FIG. 6 is flat when cut by a plane including the axial direction, the outer peripheral surface 41a in the examples of FIGS. 7A to 7F are not flat but curved. In the examples of FIG. 7A, the outer peripheral surface 41a is curved when cut by a plane including the axial direction, and is convex toward the cylindrical portion 17 of the housing 11. In the example of FIG. 7B, the outer peripheral surface 41a is curved when cut by a plane including the axial direction, and is concave in the example of FIG. 7B.

In the example of FIG. 7C, a lower part of the ring-shaped member 41 is not tapered but is cylindrical. That is, the lower part has the outer peripheral surface 41a parallel to the rotation axis. The outer peripheral surface 41a of an upper part of the ring-shaped member 41 is, however, inclined with respect to the rotation axis in such a manner that the outer diameter of the ring-shaped portion 41 decreases toward its lower cylindrical part. When cut by a plane including the axial direction, the outer peripheral surface 41a of the upper part of the ring-shaped member 41 is flat. The outer diameter of the ring-shaped member 41 is smaller at its lower end than at its upper end.

In the example of FIG. 7D, the lower part of the ring-shaped member 41 is cylindrical as in the example of FIG. 7C. However, unlike the example of FIG. 7C, the outer peripheral surface 41a in the upper part is not flat but curved when cut by a plane including the axial direction. The outer peripheral surface 41a is convex toward the cylindrical portion 17 of the housing 11. As is apparent from FIG. 7D, the outer diameter of the ring-shaped member 41 is smaller at its lower end than at its upper end.

In the example of FIG. 7E, the ring-shaped member 41 has a stepped outer peripheral surface 41a. That is, the ring-shaped member 41 is formed by a large-diameter portion and a small-diameter portion arranged on the sleeve side of the large-diameter portion. In any of those modified examples, the first outer diameter d1, i.e., the outer diameter on the sleeve 35 side of the ring-shaped member 41 is smaller than the second outer diameter d2, i.e., the outer diameter on the connection-part side. That is, d1<d2 is satisfied.

In the examples of FIGS. 7A to 7F, the sleeve side face 41b of the ring-shaped member 41 is concave away from the upper end face of the sleeve 35. When cut by a plane including the axial direction, the sleeve side face 41b is formed by a combination of flat faces in the examples of FIG. 7A to 7E. On the other hand, in the example of FIG. 7F, the sleeve-side face 41b is curved when cut by a plane including the axial direction. In the example of FIG. 7F, the outer peripheral surface 41a of the ring-shaped member 41 is the same as that of FIG. 7E. Since the sleeve side face 41b is concave away from the upper end face of the sleeve 35, lubricating oil adhering on the sleeve side face 41b moves on the sleeve side face 41b away from the rotation axis as the ring-shaped member 41 rotates, and goes back to the sleeve 35 when leaving a radially outer edge 41c.

The ring-shaped member 41 can have any shape, as long as d1<d2 is satisfied. For example, shapes obtained by combining the above modified examples or shapes other than those in the above modified examples can be used.

As described above, the present invention can be implemented in various forms. Specific structures, shapes, materials, and the like described in the aforementioned preferred embodiment and modified examples are merely examples and can be modified in various ways. For example, the rotor hub 37 may be omitted to fix the impeller 39 directly to the shaft 36.

In the aforementioned preferred embodiment, the shaft-retaining portion 33b formed by the upper end of the insulator 33 can be elastically deformed to allow the ring-shaped member 41 to pass through the hole 33a. However, the present invention is not limited thereto. Not the shaft-retaining portion 33b but the ring-shaped member 41 may be formed from an elastically deformable material (e.g., synthetic resin). It is sufficient that at least one of the shaft-retaining portion 33b of the stationary part (on the housing 11 side) and the ring-shaped member 41 of the rotating part can be elastically deformed to allow the ring-shaped member 41 to pass through the hole 33a defined in the shaft-retaining portion 33b.

In the aforementioned preferred embodiment, the shaft-retaining portion 33b is formed by a part of the insulator 33 of the stator 31. Alternatively, a separate shaft-retaining portion from the insulator 33, in which a hole allowing the ring-shaped member 41 to pass therethrough is formed, may be formed. In this case, the separate shaft-retaining portion is secured to an upper open end of the cylindrical portion 17 of the housing 11. Alternatively, a shaft-retaining portion may be formed by a part of the cylindrical portion 17 of the housing 11 by narrowing down the upper open end of the cylindrical portion 17.

As described above, according the preferred embodiments of the present invention, the ring-shaped member is secured around the shaft between the connection part of the shaft to which the rotor is connected and the connection-part end of the sleeve. The ring-shaped member has a function of preventing leak of lubricating oil axially leaking from the sleeve to the outside of the cylindrical portion accommodating the sleeve and a function of preventing the shaft from exiting from the sleeve. Therefore, the motor and the fan unit that are advantageous in simplicity of the structure and the cost can be obtained.

The ring-shaped member is coated with a repellent agent repelling lubricating oil. When the shaft is inserted into the sleeve, the repellent agent may be removed by the contact with a region of the shaft-retaining portion surrounding the hole. However, since the diameter of the hole is larger than the sleeve side outer diameter of the ring-shaped member and smaller than the connection-part side outer diameter, the repellent agent is left at least on a sleeve side part of the outer peripheral surface of the ring-shaped member. Moreover, the repellent agent is also left on the sleeve side face of the ring-shaped member. Therefore, it is possible to effectively return the lubricant oil axially leaking from the sleeve toward the sleeve and prevent leak of the leaking oil to the outside of the cylindrical portion.

Furthermore, the sleeve side face of the ring-shaped member is concave away from the connection-part side end of the sleeve. With this structure, even if lubricating oil axially leaking from the sleeve adheres to the sleeve side face of the ring-shaped member, that lubricating oil moves on the sleeve side face by a centrifugal force away from the rotation axis, leaves the outer edge of the sleeve side face, and then goes toward the sleeve. In this manner, the lubricating oil is collected to the sleeve.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a shaft rotatable around a rotation axis and connected in its connection part to a rotor;
a sleeve impregnated with lubricating oil, surrounding the shaft except for the connection part of the shaft, and supporting the shaft in a rotatable manner;
a hollow cylindrical portion having an open end and accommodating the sleeve;
a ring-shaped member secured around the shaft between the connection part of the shaft and the sleeve and coated with a repellent agent repelling the lubricating oil, an outer peripheral surface of the ring-shaped member facing the hollow cylindrical portion, the ring-shaped member having a first outer diameter at its sleeve side and a second outer diameter at its connection-part side larger than the first outer diameter; and
a shaft-retaining portion defining a hole therein and provided on the hollow cylindrical portion to be located between the connection part of the shaft and the ring-shaped member, a diameter of the hole being larger than the first outer diameter and smaller than the second outer diameter of the ring-shaped member, wherein
at least one of the ring-shaped member and the shaft-retaining portion is elastically deformable.

2. A motor according to claim 1, wherein the ring-shaped member is tapered toward the sleeve in such a manner that the first outer diameter is smaller than the second outer diameter.

3. A motor according to claim 1, wherein the outer peripheral surface of the ring-shaped member is stepped.

4. A motor according to claim 1, further comprising a stator including a core, a coil wound around the core, and an insulator insulating the core from the coil, the stator being secured to an outer peripheral surface of the hollow cylindrical portion, wherein the shaft-retaining portion is formed by a part of the insulator.

5. A motor according to claim 1, wherein the ring-shaped member is a pressed metal member.

6. A motor according to claim 5, wherein a layer of the repellent agent repelling the lubricating oil is formed on a surface of the ring-shaped member by immersing the ring-shaped member in the repellent agent.

7. A motor according to claim 1, wherein a sleeve side face of the ring-shaped member is concave in such a manner that the sleeve side face gets close to the sleeve radially outward.

8. A fan unit comprising the motor according to claim 1 and an impeller generating an air flow by its rotation, wherein the impeller is connected to the shaft of the motor directly or via a rotor hub.
